(19) United States
(12) Patent Application Publication
(10) Pub. No.: US 2026/0087056 A1
(43) Pub. Date: Mar. 26, 2026

(54) SYSTEMS AND METHODS FOR DYNAMIC GRAPH RENDERING BASED ON A HISTORICAL EVENT

(71) Applicant: ROYAL BANK OF CANADA, Toronto (CA)

(72) Inventors: Patricia AROCENA, Toronto (CA); Robert HOMEWOOD, London (GB); Arshia ABDIPOUR, Toronto (CA); John BOLTON, Hamilton (CA); Jessica ROCK, Calgary (CA)

(21) Appl. No.: 19/337,616

(22) Filed: Sep. 23, 2025

Related U.S. Application Data
(60) Provisional application No. 63/697,898, filed on Sep. 23, 2024.

(51) Int. Cl. G06F 16/34; G06F 9/451

(52) U.S. Cl. CPC G06F 16/34; G06F 9/451

(57) ABSTRACT

Systems and methods for dynamically rendering a graph based on a historical event are described. An example computer-implemented method may include: receiving, from a user device, a user input for generating a dynamic graph based on a historical event; processing the user input to compute an event identifier and a temporal data identifier; determining a set of event parameters for the dynamic graph; generating user interface (UI) data for the dynamic graph based on the set of event parameters; and generating and transmit signals for rendering the dynamic graph at the user device.

### CROSS-REFERENCE TO RELATED APPLICATIONS

This application claims all benefit including priority to U.S. Provisional Patent Application 63/697,898, filed Sep. 23, 2024, and entitled: “SYSTEMS AND METHODS FOR DYNAMIC GRAPH RENDERING BASED ON A HISTORICAL EVENT”, the entirety of which is hereby incorporated by reference.

### FIELD

Embodiments of the present disclosure relate to the field of dynamic user interfaces, and specifically, some embodiments relate to user interfaces including graph renderings of temporal data based on identifiable events.

### BACKGROUND

Temporal data is sometimes referred to as time series data. Generally defined, a temporal dataset may include a sequence of data values indexed with respect to time. Temporal data can be analyzed to provide a historical perspective and further processed to generate predictions based on historical trends, patterns, and anomalies.

Temporal data may relate to historical events in real world. For example, temporal data on the coronavirus disease (COVID-19) may include epidemiological data, hospitalization data, national birth rate data, and so on. Visualization of such temporal data in the context of a historical event may assist with future prevention or early warning of similar diseases.

Other examples of temporal data includes, without limitation, climate data relating to temperature and weather patterns, seismic data, energy consumption data, stock market data, polling data during an election, and so on.

In some situations, long time scales or granular time periods can result in large data sets.

### SUMMARY

In some embodiments, aspects of the systems and methods described herein can process time series data and natural language event information to provide a dynamic user interface including elements generated from the data. In some situations, aspects of the systems and methods can reduce processing loads, decrease rendering times, and/or reduce network and/or database loads.

In accordance with one aspect, there is provided a computer system for dynamically rendering a graph based on historical event and temporal data, the computer system may include a processor and a non-transitory memory storing one or more sets of instructions, which when executed by the processor, causes the system to: receive, from a user device, a user input for generating a dynamic graph based on a historical event; process the user input to compute an event identifier and a temporal data identifier; determine a set of event parameters for the dynamic graph; generate user interface (UI) data for the dynamic graph based on the set of event parameters; and generate and transmit signals for rendering the dynamic graph at the user device.

In accordance with another aspect, there is provided a computer-implemented method for dynamically rendering a graph based on historical event and temporal data, the method may include: receiving, from a user device, a user input for generating a dynamic graph based on a historical event; processing the user input to compute an event identifier and a temporal data identifier; determining a set of event parameters for the dynamic graph; generating user interface (UI) data for the dynamic graph based on the set of event parameters; and generating and transmit signals for rendering the dynamic graph at the user device.

In accordance with another aspect, there is provided a non-transitory computer readable medium storing machine interpretable instructions, which when executed by a processor, cause the processor to perform: receiving, from a user device, a user input for generating a dynamic graph based on a historical event; processing the user input to compute an event identifier and a temporal data identifier; determining a set of event parameters for the dynamic graph; generating user interface (UI) data for the dynamic graph based on the set of event parameters; and generating and transmit signals for rendering the dynamic graph at the user device.

### BRIEF DESCRIPTION OF THE FIGURES

In the Figures, embodiments are illustrated by way of example. It is to be expressly understood that the description and figures are only for the purpose of illustration and as an aid to understanding.

Embodiments will now be described, by way of example only, with reference to the below figures:

FIG. 1 shows an example system for dynamically rendering a graph based on historical event and temporal data, in accordance with some embodiments;

FIG. 2 is a schematic block diagram for dynamically rendering a graph based on historical event and temporal data, in accordance with some;

FIG. 3 illustrates an example data flow between system and user device for rendering a graph in real time based on user input, in accordance with some embodiments;

FIGS. 4 5, 6, 7A, 7B, 8A, 8B and 8C each illustrates a respective example user interface rendered by the user application at user device, in accordance with some embodiments;

FIG. 9 shows an example schematic diagram of a computing device that implements the system in FIG. 1, in accordance with some embodiments; and

FIG. 10 shows an example process performed by the system in FIG. 1, in accordance with some embodiments.

### DETAILED DESCRIPTION

Temporal data or time series data encapsulates data points collected sequentially over a time period, and usually presented in a chronological order to illustrate a pattern or trend during said time period. Real-world application of temporal data analytics and visualization based on one or more historical events can provide meaningful insight and patterns based on which future predictions can be made.

Traditional solutions offering graphs or charts based on historical data often struggle to provide users with the ability to freely explore or receive customized information regarding the historical events. Typically, existing applications of this kind would be limited to a predetermined set of global events that application developers have preprogrammed into the application, which generates results or graphs that are also preprogrammed, thereby limiting the users from customization.

In some embodiments, a system can be executed to render an interactive interface to provide users with a graph to show a timeline generated based on temporal data in view of a selected historical event. The user may, through the interactive interface, select a particular historical event and the type of temporal data for generating a dynamic graph or chart that is configured to adapt to user's preferences. The temporal data may be historical data or simulated data. For instance, the system can render a graph showing how a global event such as COVID-19 has impacted the birth rate or population in one or more regions over the past few years.

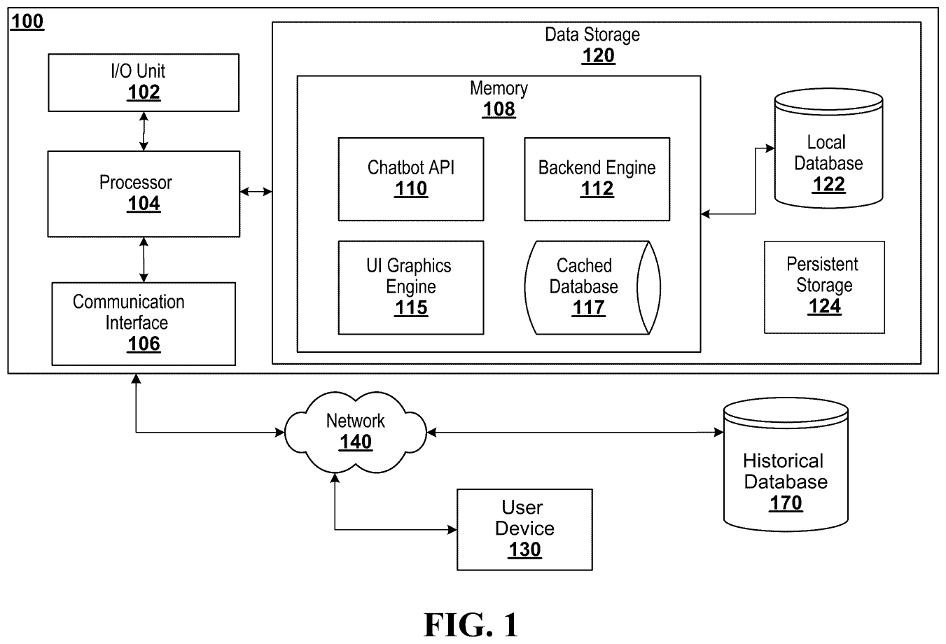

In accordance with one aspect, a system or platform 100, such as the one shown in FIG. 1, is implemented to simulate and present temporal data based on a historical event using machine learning.

In some embodiments, system 100 can be executed to render an interactive interface at a user device 130 to provide users with a graph to show a timeline generated based on temporal data in view of a selected historical event. For instance, system 100 can render a graph showing how a global event such as COVID-19 has impacted the MSCI World Index over the past years. The user may, through the interactive interface, select a particular historical event and the type of temporal data for generating a dynamic graph or chart that is configured to adapt to user's preferences. The temporal data may be historical data or simulated data.

In a high level example, a user can visualize the performance of a simulated investment portfolio starting at £10,000 since 1975, witnessing its growth up to £300,000. The example system can simulate the impact of various world events on the chosen set of temporal data (e.g., stock data simulating the investment portfolio), allowing users to see how long it would take for the value of the portfolio to recover from one or more events or to benefit from one or more events. In addition, through a chat interface, a user can request information about specific events, such as a war or pandemic, and receive a rendered graph that visualizes how the temporal data would be affected. For example, the user can look at the rendered graph and see how long it would take for a simulated investment portfolio to reach a specific value (such as its value prior to the selected event).

Further, system 100 can generate simulated temporal data and render, based on the simulated temporal data, a dynamic graph simulating the behaviour of the temporal data during a specific time frame based on additional constraints or user input. For instance, system 100 can receive generate and render a dynamic graph showing a user how investing and withdrawing £1000 at a random date during a recovery window post a selected event can help with the recovery of the investment portfolio, highlighting the benefits of staying invested during market fluctuations.

The user can interact with the rendered graphs through the chart interface connected to a chatbot application (Chatbot API) 110, which receives user input in the form of natural language text, and processes the user input in real time using a backend engine 112 to generate a narrative, which can be displayed above the dynamic graph or chart to provide contextual information on the event's impact on the temporal data and its subsequent simulation.

In some embodiments, system 100 is implemented to demonstrate the impact of global events on multiple sets of temporal data, including for example, birth rate, population data, and financial data.

By utilizing a LLM (such as e.g., GPT-4 model), users can send inquiries about a historical event via text input, and receive responses that are tailored to their query. For example, if a user asks, “what was the impact of the COVID-19 pandemic?”, the system can generate and display a text or audible response based on the user's query; while simultaneously rendering a graph using applicable temporal data, as a visual aid to further illustrate or explain the text or audible response.

Additionally, the interactive, LLM-powered chatbot feature allows users to select an event for rendering one or more graphs through a user-friendly chat interface, reducing the need for extensive training or guidance.

For instance, once a user has been provided a graph based on a selected event and a set of temporal data, the user may, through the interactive interface, zoom in on the graph through mouse-action or through touch-screen user input (e.g., multi-touch points manipulation), and the system can in real time or near real time, process the user input to adjust the granularity of the graph, and automatically re-render an updated graph with additional temporal data in the zoomed in graph.

Returning to FIG. 1, which shows a high-level schematic diagram of an example computer-implemented system 100 including an I/O unit 102, a processor 104, communication interface 106, and data storage 120. The I/O unit 102 can enable system 100 to interconnect with one or more input devices, such as a keyboard, mouse, camera, touch screen and a microphone, and/or with one or more output devices such as a display screen and a speaker. While not explicitly shown, system 100 further includes a user application implemented at user device 130. The user application may be referred to as a front-end, a web client, or a client-side application. The user application communicates with other components of system 100, including Chatbot API 110, UI graphics engine 115, and backend engine 112, to dynamically render and display a graph based on a historical event and one or more sets of temporal data.

Data storage 120 including a memory device 108 (also referred to as memory 108), a local database 122, and persistent storage 124. Memory 108 include one or more instruction modules stored thereon, such as for example, Chatbot API 110, backend engine 112, and UI graphics engine 115, and a local cached database 117.

Processor 104 is configured to execute machine-executable instructions to perform processes disclosed herein, including for example processing user input through Chatbot API 110, generating one or more responses using backend engine 112, generating data for rendering user interface using UI graphics engine 115.

System 100 can connect to a user application installed on user device 130 to exchange signals representing user input, response to user input, data for rendering one or more graphs or charts, and so on. The user application interacts with system 100 to exchange data (including control commands) and generates visual elements for display at user device 130 based on the data and command signals from system 100. The visual elements can represent one or more graphs, text, or audible files.

For greater certainty, a user application can refer to a web-based application such as a web browser, or an application installed on the user's device.

System 100 can connect to different data sources, including third party sources to receive input data or to transmit other data. For instance, system 100 can receive and transmit real time data from internal and/or external data sources, such as, for example, a remote historical database 170 storing historical data. System 100 can store, on a local memory device, available historical data and update the stored historical data when the application is run with any new information.

Historical data can be transmitted and received via network 140 (or multiple networks), which is capable of carrying data and can involve wired connections, wireless connections, or a combination thereof. Network 140 may involve different network communication technologies, standards and protocols, for example.

System 100 may, in some embodiments, store a portion of data received from historical database 170 in a cached store or database 117 for dynamically rendering one or more graphs based on user commands or user inputs.

Processor 104 can execute instructions in memory 108 to implement aspects of processes described herein. Processor 104 can execute instructions in memory 108 to configure various components and functions described herein. Processor 104 can be, for example, any type of general-purpose microprocessor or microcontroller, a digital signal processing (DSP) processor, an integrated circuit, a field programmable gate array (FPGA), a reconfigurable processor, or any combination thereof.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), ferroelectric RAM (FRAM) or the like. Data storage devices 120 can include memory 108, databases 122, and persistent storage 124.

Communication interface 106 can enable system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

System 100 can be operable to register and authenticate users (using a login, unique identifier, and password for example) prior to providing access to system 100 through a web-based portal interface or through a user application on user device 130 connected to a server via the internet. For example, the user application can be a browser instance of a browser application installed on the user device 130. In some embodiments, user authentication process may be handled via an authentication module (not shown).

Data storage 120 may be configured to store information associated with or created by the components in memory 108 and may also include machine executable instructions. Memory 108 may be persistent memory storage. Data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

References to components, engines, modules and the like can be provided by computer readable code executable by one or more processor(s) on one or more devices to perform the steps or functions described.

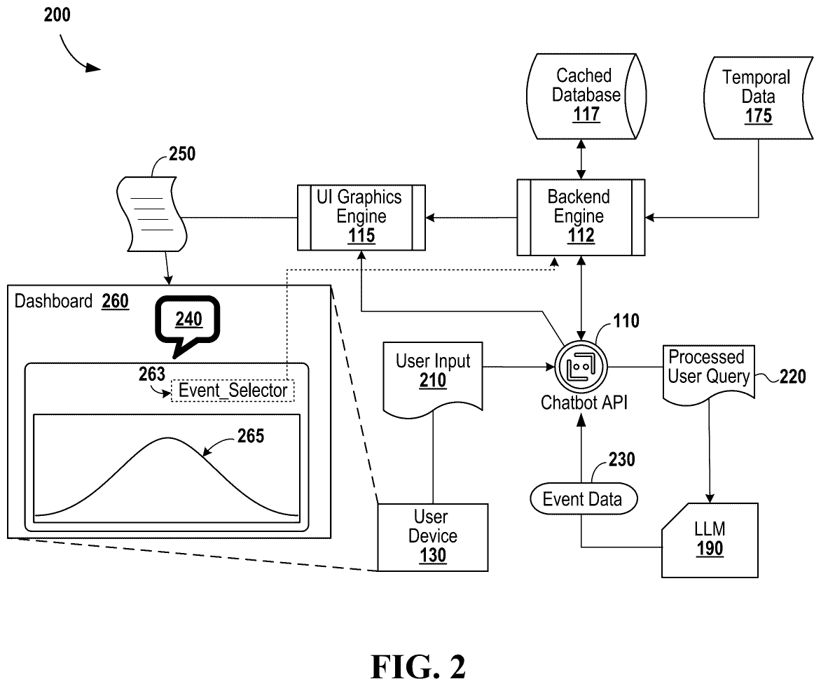

FIG. 2 is a schematic block diagram 200 for dynamically rendering a graph based on historical event and temporal data, in accordance with some embodiments. Even though FIG. 2 primarily shows a process, some components shown in FIG. 2 are entities for storing, receiving or generating data. The processes described herein may be performed by components of system 100 in accordance with instructions stored in memory 108.

Event selection by a user may be implemented in one or more configurations. For example, user input 210 is entered by a user and received by system 100 through a chat interface 240. The chat interface 240 may be rendered based on instructions and data from Chatbot API 110. One or more user input 210 is received by Chatbot API 110 from user device 130 via chat interface 240. In some embodiments, user input 210 may include, for example, a name or a brief description of a historical event. Chatbot API 110 may process and analyze user input 210 as processed user query 220, which is described in detail below, and sends the processed user query 220 to LLM 190 for identifying an event, the identified event is represented in event data 230, which is returned to Chatbot API 110. A graph 265 is then generated and rendered on the dashboard 260 in real time in response to the user input 210 sent via chat interface 240.

In some embodiments, an optional event selector GUI element 263 is provided for event identification. For example, the user input 210 may be received in response to the GUI element 263 (“Event_Selector” dropdown menu) presenting a list of events presented on a visual dashboard on user device 130. For example, the GUI element 263 may include an Event Selector Dropdown element in which the user can select from a predetermined list of events, without needing to query Chatbot API 110 for event identification. User input 210 may include, for example, a data value indicating a user-selected historical event. The data value may be sent directly to a backend engine 112 for processing for rendering a graph 265 on the dashboard in real time in response to the user input 210.

Chatbot API 110 may include, for example, a Flask API Python™ script responsible for managing interactions with the Large Language Model (LLM) 190. Various LLM may be implemented, both on-premises and cloud-based. For instance, Chatbot API 110 can integrate with OpenAI's ChatGPT Python™ library.

Chatbot API 110 receives user input 210 and processes said user input 210 to generate a processed user query 220, which is then sent to LLM 190 for further processing, and in response, the LLM 190 transmits a set of event data 230 to Chatbot API 110. Event data 230 may includes event identifier indicating a specific event and a temporal data identifier indicating a set of temporal data for rendering a graph 265. Example event data 230 may include, for example, one or more of: an event identifier, a start date for a specific event identified by event identifier, an end date for the specific event, a geographical location or region for the specific event, and so on.

Chatbot API 110 may be, for example, configured to communicate with OpenAI's GPT-4 Turbo (or Llama, as another non-limiting example) for LLM 190, and facilitates communication between the LLM 190 and the other components of system 100 in an efficient manner.

Chatbot API 110 may, as an optional feature or step, transmit the event data 230 to user device 130 and request user confirmation that this is the correct event selected by the user via a chat interface.

Once it has been determined that event data 230 accurately represents the user-selected event, Chatbot API 110 may send event data 230 and temporal data identifier to backend engine 112 for further processing.

Backend engine 112, based on the event data 230 and temporal data identifier, is configured to retrieve one or more sets of historical temporal data 175 from internal or external databases. An example backend engine 112 may include a component implemented using Flask API Python™ script.

Backend engine 112 may, based on the temporal data identifier, determines at least one type of temporal data selected by the user, and subsequently retrieves the appropriate temporal data 175 based on the event data 230. For instance, backend engine 112 can retrieve historical market or stock data from an external database (e.g., Python™ Datastream DSWS data library) based on a start date and end date for the specific event in event data 230.

In some embodiments, backend engine 112 may selectively and temporarily store (“cache”) some or all of the retrieved historical temporal data in a local database 117 (cached database 117). By caching frequently accessed historical temporal data, system 100 can significantly reduce response times when querying specific temporal data in specific given time frame, as it eliminates the need to repeatedly query the slower, more remote external database.

Cached database 117 is used for storing and retrieving previously fetched data. For example, cached database 117 may include a simple database file (“events.db” file) interfaced with backend engine 112. In some embodiments, cached database 117 may include a full-fledged SQL database as needed.

In some embodiments, the cached database 117 may include a database storing historical temporal data for one or more default historical events. The one or more default historical events may correspond to, for example, the list of events in the GUI element 263 (“Event_Selector” dropdown menu) presented on a visual dashboard on user device 130

UI graphics engine 115 may include a server-side engine that generates UI data 250 for a client server (e.g., an application on client device 130) to render and display UI elements, which may include one or more graphs and other types of visual elements on the dashboard as part of the user interface provided by system 100. The UI elements may be rendered entirely at the client side (e.g., user device 130), or may be partially rendered at the server side (e.g., system 100), or may be entirely rendered at the server side prior to being transmitted to client device 130. It is to be understood that the regardless of the specific server(s) used to render the eventual graph, the UI data 250 necessary for rendering said graph is generated and provided by system 100.

For example, UI graphics engine 115 may include a React™-based component that generates UI data for rendering and displaying the graphs and for providing a user interface for interacting with system 100 via dashboard and Chatbot API 110. This component leverages all the backend engine 112 to deliver an efficient user experience.

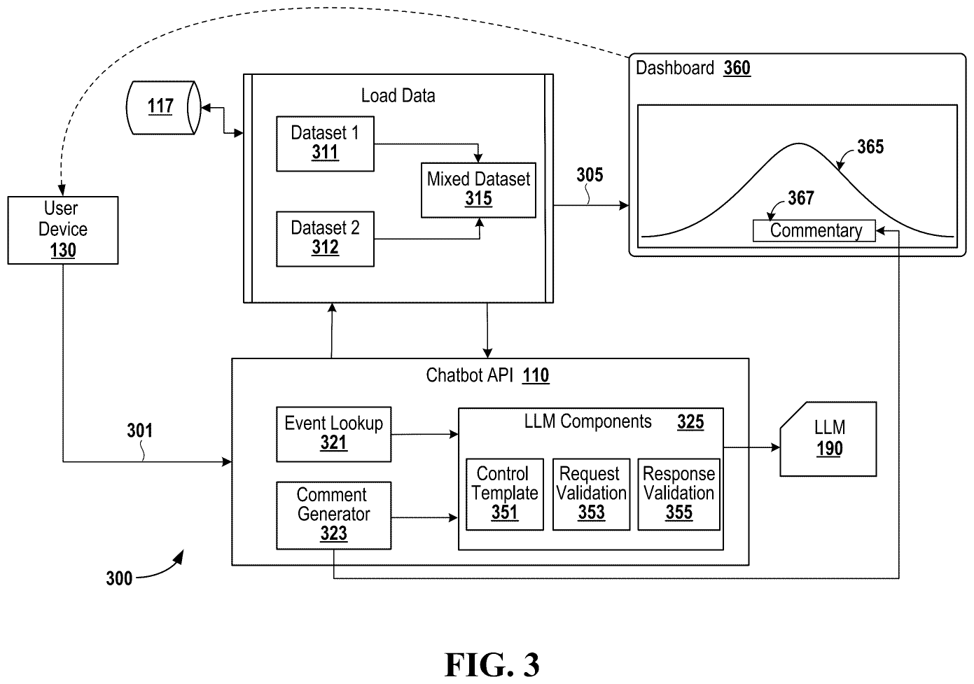

FIG. 3 illustrates an example data flow 300 between system 100 and user device 130 for rendering a graph 365 in real time based on user input 301. In some embodiments, Chatbot API 110 first receives and processes user input queries 301 received through a dashboard at user device 130, which may be processed using an event lookup component 321 to compute an event identifier (e.g., COVID-19) and one or more temporal data identifiers. In the case of two temporal data identifiers (e.g., hospitalization rate and death rate), a first temporal dataset 311 and a second temporal data set 312 may be identified.

Chatbot API 110 also includes one or more LLM components 325, which may include a control template 351, a request validation component 353 and a response validation component 355, for communicating with LLM 190. The event lookup component 321 interfaces LLM 190 through the LLM components 325, and sends the user inquiries 301 to the LLM 190, and receives a response from LLM 190 indicating a user-selected or user-identified event, one or more temporal data identifiers, and other relevant information regarding the event.

Chatbot API 110 then generates and sends a response (e.g., a JSON response) containing information about the user-selected event back to user device 130. For instance, the response may include event data such as start and end dates for the event, and additional event information such as a date identified based on the temporal data. For example, if the user input 301 indicates that the temporal data is hospitalization rate in the United States, the additional event information may include a date that is two weeks prior to when the hospitalization rate first experienced fluctuations due to the identified event (e.g., COVID-19). The response can also include a brief description of the event for the user's reference to confirm or deny the accuracy of the event.

The temporal data identifier(s) are then sent to backend engine 112 for retrieving temporal data. In the case of two temporal data identifiers (e.g., hospitalization rate and death rate), a first temporal dataset 311 and a second temporal data set 312 may be identified, and used by backend engine 112 to retrieve a mixed data set 315 from one or more temporal data databases. In the case of only one temporal data identifier, only the first temporal dataset 311 is retrieved by backend engine 112.

In some embodiments, for example, temporal data identifiers may include bounds, stock index, and mixed portfolio, for a user query relating to stock market during an event.

The retrieved temporal datasets 311, 312, 315 may be initially loaded by backend engine 112, and a portion or all of the retrieved temporal datasets 311, 312, 315 may be cached in cached database 117.

In some embodiments, the temporal datasets are stored at a server or other computing device which is connected (e.g. via a network or communication bus) to the local computing device 130 on which a generate user interface element is displayed. In some embodiments, the cached database is stored on the local computing device and is updated via the communication network.

In some embodiments, the temporal datasets can be stored in a slower storage device such as a hard drive and the cached database can be stored in a faster storage device (e.g. a storage device providing shorter access times) such as RAM.

The retrieved temporal datasets 311, 312, 315 are used by UI graphics engine 115 to generate UI data 305 for a dynamic graph 365 based on retrieved temporal datasets 311, 312, 315. The generated UI data 305 is then transmitted or used by the user device 130 for rendering and displaying a dynamic graph 365 on dashboard 360 at the user device 130. In some embodiments, the UI data is generated by the user device 130 based on cached data and/or a subset of the temporal datasets.

Once user device receives or generates the UI data 305, the user application automatically renders the UI elements and displays the dynamic graph 365 based on UI data 305, with additional event information regarding the graph 365 and the specific event, which may include a brief description of the event, and/or a summary analysis of the temporal data sets used to generate the graph 365. The additional event information may be then displayed to the user as a comment 367 together with the graph 365 for easy reference and understanding. The additional event information thereby provides users with valuable insights into the data they are analyzing.

In order to generate the most appropriate comment 367 about the specific event, a comment generator 323 of Chatbot API 110 may receives the relevant information for display from LLM 190, which can generate the text for display based on a set of event information including for example, event name, event dates, recovery window, and so on.

In addition, Chatbot API 110 may receive further user input after the graph 365 has been rendered at the user device 130, and in real time or near real time, update the displayed information including the graph 365 and/or the additional event information accordingly. For instance, Chatbot API 110 may receive an additional user input requesting a zoomed-in view of graph 365 approximately 10 seconds after the graph 365 has been rendered at the user device 130, or additional user input requesting a short explanation of a peak in the graph 365 in view of the event. Chatbot API 110 is configured to send the additional user input to LLM 190 for identification of relevant event dates and generation of an updated comment, and generates updated UI data for updating one or more of the graph 365 and the comment 367, which are then sent to user device 130 in real time for rendering the updated graph and/or comment.

### Example Practical Application

In a first example of practical application, a user may be interested in financial market performance during a historical event such as COVID-19. The financial market performance may include, for example, world MSCI market performance.

Chatbot API 110 may determine, through LLM 190, that the event identifier is COVID-19, and the temporal data set is world MSCI market performance data set. Backend engine 112 may retrieve the relevant temporal data accordingly from an external database (e.g., Datastream DSWS Python™ data library).

During an initial load phase, backend engine 112 receives event information including event identifier and temporal data identifiers from Chatbot API 110, and determines that there is currently no cached data for said event. In this case, backend engine 112 may initialize and pre-populate an events database table as part of cached database 117.

In some embodiments, cached database 117 includes an event table containing a set of a set of pre-determined world events that may be used to generate an UI element 263 for providing the user with a quick selection of events. For instance, a dropdown menu “Event_Selector” 263 may present the user with a set of events for selection. In this case, an example schema for the event table in cached database 117 may take the following form.

Schema:

eventID INTEGER PRIMARY KEY AUTOINCREMENT,
eventName TEXT NOT NULL,
eventDescription TEXT,
eventStartDate TEXT,
eventEndDate TEXT

In some embodiments, backend engine 112 may initialize (during initial load) and maintain an individual temporal data table, such as individual index/stock table, containing cached dataset from 1975 to present for the respective index/stock. (e.g., msci_table, cash_table, etc.). Each row in the table represents a periodic (e.g. daily) data point for the index/stock. In this case, an example schema for the individual temporal data table in cached database 117 may take the following form.

Schema:

date TEXT PRIMARY KEY,
idx INTEGER,
value REAL

Backend engine 112 may then populate the content in the individual temporal data table by retrieving the most up to date data (1975-present day) for the pre-selected indexes and stores them in the respective tables.

On an initial load of the temporal data sets upon first receiving the temporal data identifiers from Chatbot API 110, backend engine 112 may return, to UI graphics engine 115 and Chatbot API 110, JSON representations of database tables for loading into a user application memory (/api/get_cash_values, /api/get_msci_world_values, /api/get_ftse_gilts_values).

Once a user input has been received and processed by Chatbot API 110, on query for a specific historical event, backend engine 112 may get route “/api/get_msci_world_values”, and query parameters for a start date for the event passed from Chatbot API 110 and LLM 190.

In some embodiments, in efficiently generating the temporal data for simulating graph 365, backend engine 112 is configured to query the appropriate database with the start date of the event to find a position (e.g., an index) storing the specific temporal data in the list representation of the cached table in cached database 117.

In some embodiments, the processor(s) are configured to calculate a cache offset indices based on the event time/date (for events associated with a single time) or the times/dates (for events having start and end times). In some embodiments, the cache offset indices includes a first index which is offset by a period of time before the start time of the event, and a second index which is offset by a period of time after the end time of the event (or first and second indices offset before and after the of time an event associated with a single time).

In some embodiments, the offset is used to identify and cache time series data surrounding the event period(s) to best illustrate the effect of the event(s) on the time series data and/or to define the range of time series data over which user interface data (e.g. graph data) generated for rendering on the display.

In some embodiments, the offset is a defined value such as 1 month, 1 year, 3 quarters, 30 time periods, etc. In some embodiments, the offset is proportional to the duration of the event. For example, if the event lasts 1 year long, the offsets can be 1 or 2 years before and after the event to capture the data which may be illustrative of trend lines before and after the event.

In some embodiments, the offset is calculated based on the trend lines of the actual time series data. For example, using least-squares and/or other higher order polynomial regressions, the processor(s) can be configured to determine a range of data before and after the event time period(s) which would be illustrative of trend lines. This range of time series data can then be cached and/or requested, communicated and/or rendered to facilitate the display of the graph user interface elements.

In some embodiments, an offset can be determined to be a time period at which the data value has returned to its former value or to its former trend after the event period has ended.

These offsets can be used and applied to any references to start and end dates in the example embodiments described herein.

Backend engine 112 may call and execute helper functions to calculate the first row where the market value equals or is greater than the market value on the start date, uses datetime functions to calculate difference in time periods (e.g. weeks) between the start and end date, to quickly identify the position for the specific temporal data in cached database 117.

Backend engine 112 then constructs a JSON response object containing the required temporal data for the UI graphics engine 115 to generate the UI data for an user application at user device 130 to generate the graph 265.

As described above, Chatbot API 110 is configured to facilitate interactions with LLM 190. Chatbot API 110 allows users to query historical market data in natural language, leveraging the power of LLM 190 provide detailed event analyses and insights. Meanwhile, backend engine 112 handles the retrieval of historical market data from the external database and interfaces with a local cached database 117 to serve this data efficiently.

The cached database 117 stores historical data, which may include historical temporal data, organized into tables for quick access and retrieval. It includes an “events” table, which catalogues significant world events, and various individual temporal data (e.g., index/stock) tables, each containing extensive datasets that track the value of the temporal data (e.g., market value of each index or stock) over time. One of the important feature of system 100 is efficient caching mechanism. By caching frequently accessed data in the cached database 117, system 100 significantly reduces response times. This mechanism eliminates the need to repeatedly query the slower, larger library, thereby enhancing computing performance.

In some embodiments, as described above, multiple sets of tables in cached database 117 is maintained by backend engine 112 to store temporal data sets and events. An example set of pseudo code is provided below for setting up the tables in the cached database 117 by backend engine 112, where example temporal datasets are index stock values.

```
FUNCTION createTables( ):
  tableInfo = {
    ‘cash_values’: ‘date’,
    ‘msci world values’: ‘date’,
    ‘sp_500_values’: ‘date’,
    ‘ftse_gilts_values’: ‘date’|
  }
  FOR tableName, primaryKey IN tableInfo.items( ):
    CREATE TABLE IF NOT EXISTS tableName (
      date TEXT PRIMARY KEY,
      idx INTEGER,
      value REAL
    )
    CREATE INDEX IF NOT EXISTS
    tableName_date_index ON tableName(date)
```

In this example, backend engine 112 fetches historical market data from the external database. This step involves connecting to the external database (or streaming data service), retrieving the appropriate data, and storing the data in cached database 117. In this process, backend engine 112 generates appropriate tables with a primary key (idx) for each entry. This primary key is used to map the database entries to a 0-based index list in the front-end for efficient querying later in the flow. An example set of pseudo code is provided below for retrieving and storing historical temporal data in cached database 117.

```
  FUNCTION storeMSCIWorldValues( ):
    IF msci_world_values_in_db:
      RETURN True
    ds = dsws.Datastream(username=DS_USERNAME, password=DS_PASSWORD)
    data = ds.get_data(‘MSWRLDS$’, [‘X(RI)~GBP’],
    ‘1970-01-01’, getDefaultEndDate( ), ‘D’)
    data = data.fillna(0).to_dict( )[“MSWRLD$”]
    FOR key, value IN data.items( ):
      insertIntoTable(‘msci_world_values’, key, value)
    msci_world_values_in_db = True
    RETURN True
  FUNCTION insertIntoTable(tableName, date, value):
    CONNECT to database
    FETCH max index from tableName
    SET idx to max index + 1 OR 0 if no entries
    CHECK for duplicate entry with date and value
    IF no duplicate:
      INSERT (idx, date, value) into tableName
      COMMIT changes
,
```

Each entry is assigned an index or idx that serves as a primary key, which facilitates efficient retrieval of data subsets by providing start and end indices. The front-end can then map these indices to a 0-based index list in memory.

In some embodiments, backend engine 112 retrieves the full dataset from the in cached database 117 and loads it into frontend, e.g., transmits to the user device 130 for loading. This allows the user application at the user device 130 to store the dataset in a list, making it readily available for efficient querying and interaction. On rendering the user interface, the user application at the user device 130 fetches the full dataset from backend engine 112 (or UI graphics engine 115) and stores it in a list for use. An example set of pseudo code is provided below for the user application at user device 130 for requesting full dataset from backend engine 112.

```
FUNCTION initializeGraph( ):
  stockData = FETCH(“api/get_msci_world_values?all=true”)
  bondsData = FETCH(“api/get_ftse_gilts_values?all=true”)
  mergedData = MERGE(stockData, bondsData)
  processedData = PROCESS(mergedData)|
  SET chartData TO processedData
```

As backend engine 112 receives a query parameter to request the full dataset from user application at user device 130, when the all=true flag is used, it returns the entire dataset as a list. The function getMSCIWorldValues handles requests for the full dataset, checks the cache, and retrieves data from the database. It returns the full dataset as a list when the all=true flag is used.

An example set of pseudo code is provided below for backend engine 112 to return the requested data. The function getMSCIWorldValues handles requests for the full dataset, checks the cached database 117, and retrieves data from the cached database 117. It returns the full dataset as a list when the all=true flag is used. On page load, the user application at user device 130 fetches the full dataset using FETCH and initializes the graph 365 based on the fetched data and UI data from UI graphics engine 115.

```
FUNCTION getMSCIWorldValues( ):
  IF dataNotInCache:
    storeMSCIWorldValues( )
  IF fullDataRequest:
    RETURN fullDatasetAsJson( )
  ELSE:
    RETURN error(“data not in db”)\
```

In some embodiments, an example user application at user device 130 is a web client built in JavaScript™. Users can view and interact with a rendered graph 365 that displays historical and/or simulated temporal data, query the database for specific events, and receive comprehensive analyses on the same user interface. This interface is designed for ease of use, ensuring that even complex data is presented in a clear and user-friendly manner.

As is illustrated by the pseudocode, in some embodiments, the processor(s) are configured to request and return full datasets. However, in some situations, the processor(s) are configured to access and cache or otherwise store only a subset of the time serie(s) data associated with an event (and if applicable their offsets).

For example, the user application at user device 130 may be built using React library with components defined as per below:
1. App.js—main component that loads all other components of the application;
2. Title.js—component that displays the dynamic title, changing based on the users queries;
3. Header.js—component that displays the dynamic description, recovery times and ending portfolio values, changing based on the users queries;
4. Stockchart.js—a ReCharts component responsible for rendering the graph and controlling user interactions with said graph; and
5. chatButton.js—component for communicating with Chatbot API 110, uses various HTTP POST calls to interface with Chatbot API 110 in order to respond to user queries.

In some embodiment, the web client at user device 130 is configured to leverage backend HTTP APIS and Recharts augmented with custom control or rendering logic to render and display a seamless user interface including the dynamic graph 365, the comment 367 and the chat interface.

### User Query and LLM Interaction

In an example application of system 100, a user interacts with the chat interface 240 provided by user application 130 at user device 130 to query about a historical event. Chatbot API 110 processes the query via LLM 190, which returns event data 230, including one or both of an event identifier and an event date. For example, LLM 190 can process the user query 220 and return an event date in JSON format.

Backend engine 112 may use the returned event date to calculate the end date of the event and fetch the relevant temporal data, returns an object containing the start and end indices of the subset for easy indexing in the front-end.

In some embodiments, the start and end indices can include the offsets as described herein. In other embodiments, the offsets are added after the start and end indices are returned from the engine.

In some embodiments, the LLM is configured to determine event date(s) and a confidence score. For example, in some situations, event start/end dates may not be precisely defined (e.g. the lockdown period during the COVID-19 pandemic) so the LLM may return a lower confidence score for the identified start/end times.

In some embodiments, when the confidence score is below a defined threshold (e.g 90%), the system can be configured to increase the size of the start/end time offsets.

In some embodiments, the system is configured to cache a sampling of the time series data based on the offsets and/or the event dates. For example, if an event is months long and the time series data includes daily indices, the system can be configured to only retrieve and/or cache time series data sampled once every 7 days for rendering a graph with weekly data points.

In some embodiments, the daily or otherwise more granular data (or a wider offset range) can be retrieved/cached in the background while the graph with the weekly data is being displayed. In some situations, this can enable the system to quickly re-render updated graphs when it receives user input without necessarily having to wait for the additional data to be retrieved.

Backend engine 112 may, upon receiving an initial request for rendering a graph from user application 130, initialize an instance of a local database 117 for storing a list of temporal data sets. The temporal data sets can be time-indexed in the local database 117 based on, for example, temporal stamps. Temporal stamps may include, for example, timestamp, datestamp.

An example set of pseudo code is provided below for Chatbot API 110 to transmit the user inquiry to LLM 190, receives the response from LLM 190, and updates the chat interface with a suitable response.

```
FUNCTION sendMessage( ):
  IF message IS EMPTY:
    RETURN
  data = {“user_message”: “DATE QUERY: ” + message}
  TRY:
    result = POST(“api/openai/dateQuery”, data)
    responseDate = result.data.date
    botResponse = {“text”: result.data.message + “ |
    Does this look right?”, “isBot”: true}
    REMOVE “Working on it...” FROM messages
    ADD botResponse TO messages
  EXCEPT:
    PRINT(‘Error sending message’)
  FINALLY:
    SET isLoading TO false |
    verifyDate( )
```

This example set of pseudo code below handles the user's query, processes it through LLM 190, and returns the response from LLM 190 in JSON format to the user application at user device 130.

```
@app.route(‘/openai/dateQuery’, methods=[‘POST’])
def date_query( ):
  TRY:
    data = request.json
    user_message = data.get(‘user_message’)
    system_message = “You are a helpful assistant...”
    IF “DATE QUERY” IN user_message:
      conversation = [user_message]
      system_message += “Serve a date and a
      summary in JSON format.”
    # Process the conversation and get response from LLM
    response = CALL_OPENAI_API(system_message, conversation)
    RETURN response
  EXCEPT Exception AS e:
    RETURN jsonify({‘error’: str(e)}), 500
```

In some embodiments, an end date is calculated by finding the first index within a certain minimum time frame (e.g., 5 days) where the temporal data value is greater than or equal to the start value. This ensures that the data subset represents a significant period of market performance relevant to the user's query. An example set of pseudo code is provided below for calculating an end date and returning the appropriate index. This route retrieves temporal data based on the start date, calculates the end date, and formats the data for the front-end.

```
@app.route(‘/api/get_msci_world_values’, methods=[‘GET’])
def get_msci_world_values( ):
  IF NOT msci_world_values_in_db:
    store_msci_world_values( )
  start_date = request.args.get(‘start’, ‘1970-01-01’)
  end_date = request.args.get(‘end’, getDefaultEndDate( ))
  TRY:
    dateQueryRes = getDateIndicies(‘msci_world_values’, start_date, end_date)
    formatted_json = {
      “Header”: “{ } Days”.format(getRecoveryWindow(dateQueryRes[2], dateQueryRes[3])[1]),
      “Data”: [{
        ‘start_date_index’: dateQueryRes[0],
        ‘end_date_index’: dateQueryRes[1],
        ‘start_date’: dateQueryRes[2],
        ‘end_date’: dateQueryRes[3]
      }]
    }
    RETURN jsonify({‘status’: ‘ok’, ‘json_data’: formatted_json})
  EXCEPT:
    RETURN jsonify({‘status’: ‘failed’, ‘error’: ‘Error fetching data’})
```

An example set of pseudo code is provided below for finding the end date and indices.

```
FUNCTION getDateIndicies(table_name, start_date, end_date=None): |
  data = QUERY_TABLE(table_name, start_date, end_date)
  start_date_row = FIND_ROW(data, start_date)
  IF NOT start_date_row:
    RETURN [False, “start date not found”]
  start_date_index, start_date_value = start_date_row
  IF end_date IS None:
    min_desired_index = start_date_index + 5
    FOR row IN data[min_desired_index:]:
      IF row [‘value’] >= start_date_value:
        RETURN [start_date_index, row[‘idx’],
        start_date, row[‘date’]]
    RETURN [False, “recovery not found”]
  ELSE:
    end_date_row = FIND_ROW(data, end_date)
    IF NOT end_date_row:
      RETURN [False, “end date not found”]
    end_date_index, _ = end_date_row
    RETURN [start_date_index, end_date_index,
    start_date, end_date]
```

An example set of pseudo code is provided below for return object to user application at user device 130 (front-end).

```
{
  “Header”: “10 Days”,
  “Data”: [{
    “start_date_index”: 100,
    “end_date_index”: 110,
    “start_date”: “2021-01-01”,
    “end_date”: “2021-01-11”
  }]
}
```

### Dynamic Graph Rendering

The indices received from system 100 are passed to the user application at user device 130, allowing the user application to efficiently index into its pre-initialized data list. This enables the front end to quickly create the subset needed for the graph display. By using the start and end indices, the user application at user device 130 extracts the relevant data segment and updates the graph accordingly. As shown in the example pseudo code below, useEffect hook ensures that the graph data is updated whenever there is a change in chartData. This process optimizes the display by minimizing the data processing time. The user application uses the indices to create a subset of chartData used to tender the graph 365.

```
USE_EFFECT WHEN chartData CHANGES:
  IF NOT inEventView:
    chartDataSubset = calculateFrequency(chartData, startIdx, endIdx)
    IF chartDataSubset IS VALID:
      SET chartDataDisplayed TO chartDataSubset
      SET dataIndex TO {start: 0, end: LENGTH OF
      chartDataSubset − 1}
      SET trackingIndex TO {startTrackingIndex: 0,
      endTrackingIndex: endIdx}
    ELSE:
      LOG “Invalid data structure”
      SET chartDataDisplayed TO EMPTY ARRAY
```

As described throughout the disclosure, system 100, which includes user application at user device 130, is configured to dynamically adjust the data frequency for the graph based on the selected range, enhancing both readability and performance. Overall, this comprehensive system ensures that accurate and efficient temporal data are retrieved and corresponding graph rendered, providing valuable insights for users. The integration of backend processing, LLM interactions, and front-end data visualization creates a tool for understanding temporal data responses to historical events.

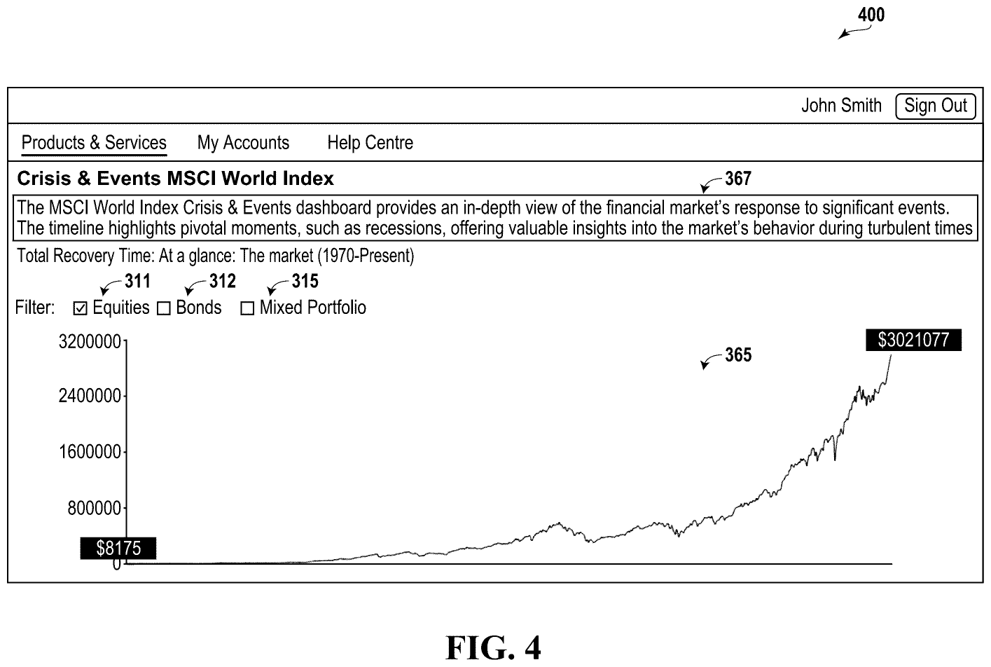

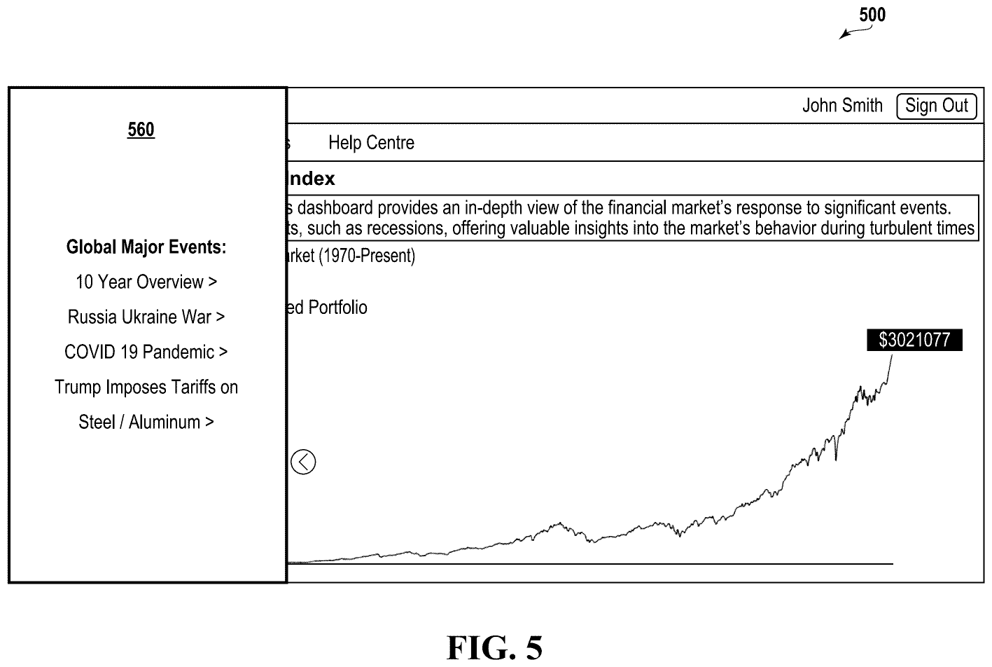

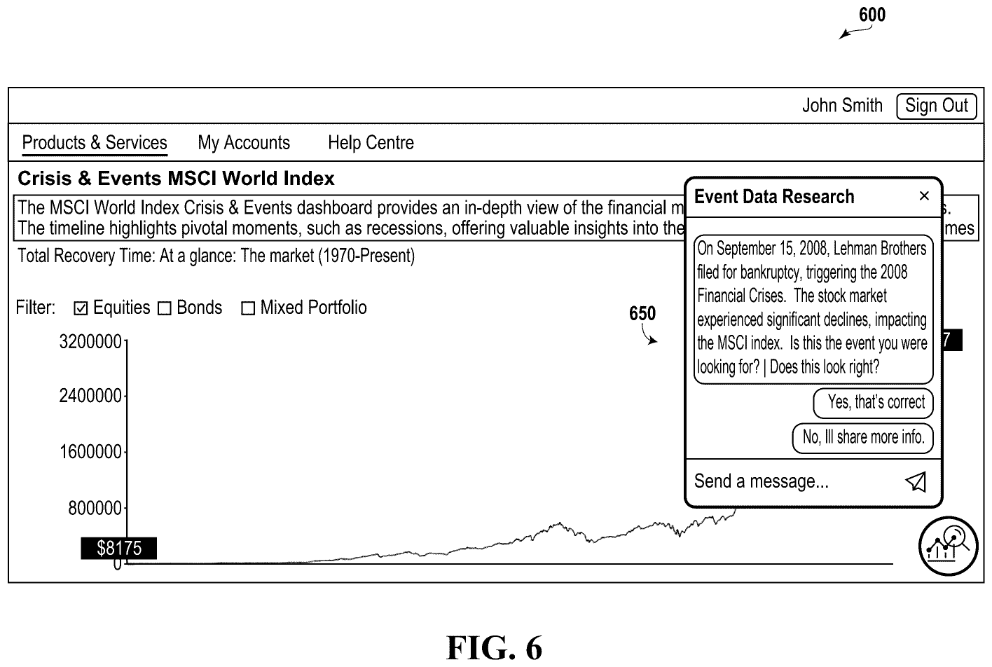

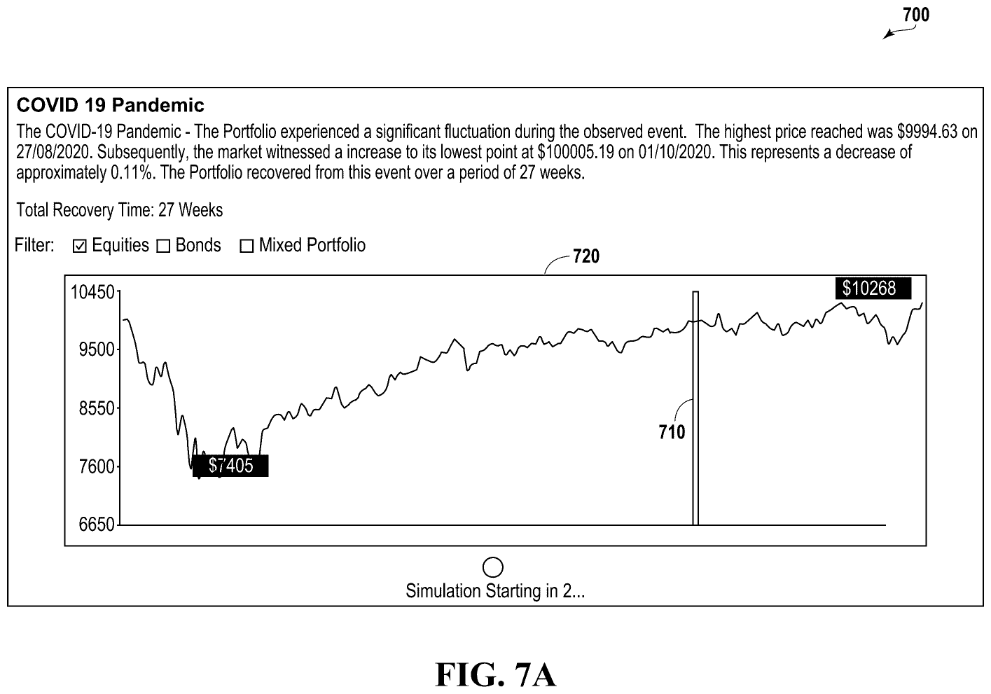

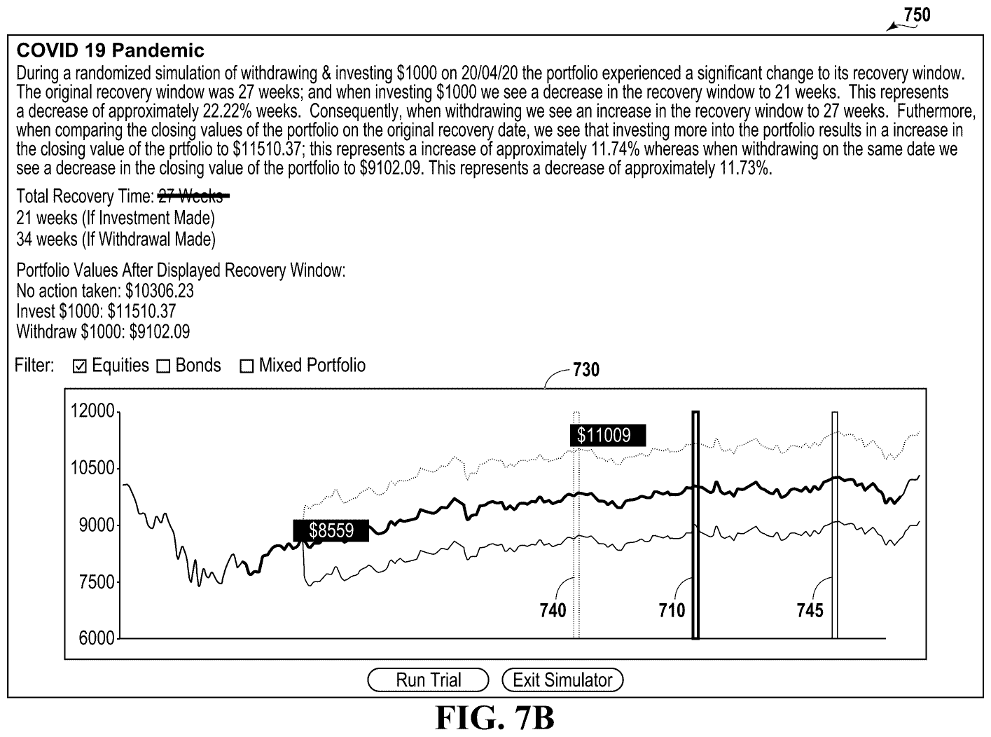

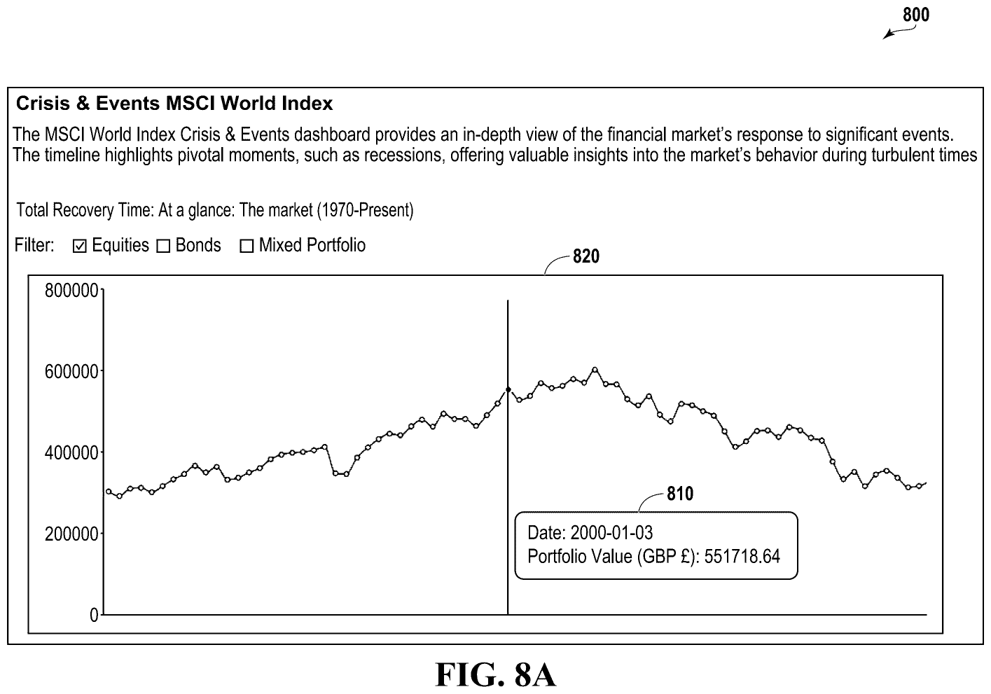

FIG. 4 illustrates an example user interface 400 rendered by the user application at user device 130 based on UI data from system 100. The user interface 400 includes a graph 365, identifiers for temporal data sets 311, 312, 315, and a comment 367 above the graph 365.

FIG. 5 shows another example user interface 500 rendered by the user application at user device 130 based on UI data from system 100. The user interface 500 includes a UI element 560 displaying a list of world events for user selection.

FIG. 6 shows another example user interface 600 rendered by the user application at user device 130 based on UI data from system 100. The user interface 600 includes a UI element 650 displaying a chat interface for receiving user input and for communicating with the user.

FIG. 7A shows an example user interface 700 rendered by the user application at user device 130 based on UI data from system 100. The user interface 700 includes a rendered graph 720, which illustrates data points along a time series: values of the temporal data (e.g., equities) are rendered on y-axis, whereas respective date or time (e.g., datestamp) for the temporal data is shown along x-axis. For clarity of illustration, datestamps along x-axis are not shown in FIG. 7A. Graph 720 includes an UI element 710 for indicating a time window (or date) during which the temporal data set experiences a critical event (e.g., recovery of pre-event value after 27 weeks).

FIG. 7B shows another example user interface 750 rendered by the user application at user device 130 based on UI data from system 100. The user interface 750 includes a rendered graph 730 including three UI elements 740, 710, 745, each indicating a respective time window (or a respective date) during which the temporal data set experiences or is expected to experience a respective critical event (e.g., recovery of pre-event value after 21, 27, or 34 weeks). As illustrated, graph 730 includes two additional temporal data sets (in addition to graph 720 in FIG. 7A), each simulated to showcase a different scenario, namely: UI element 740 represents a recovery window of 21 weeks if investments are made, and UI element 745 represents a recovery window of 34 weeks if withdrawals are made.

At onset initialization of an instance of the user application 130, an event identifier and relevant parameters (e.g., dates) are determined based on user input 210 and sent to backend engine 112, which retrieves relevant historical temporal data (also referred to as “historical data”) from an external database 170, and stores the historical data locally (e.g., “events.db” file) in cached database 117. An index is generated and maintained for the historical data in cached database 117 for efficient retrieval and update of the historical data stored locally. For example, the historical data may be time-indexed or date-indexed.

When a user command or input for updating an existing rendered graph is received by system 100 (e.g., via mouse click or touch screen signal), system 100 is configured to reference the index of the stored historical data in cached database 117, and retrieve a subset of the stored historical data for re-rendering the graph dynamically, in real time.

For instance, the user input may include a command for viewing additional data points in a selected region-of-interest in a rendered graph 720. The user input may be in the form of a touch screen signal or a text input. Once system 100 receives the user input, it is configured to generate, in real time, an enlarged view of the region-of-interest with additional data points retrieved from the local cached database 117. The region-of-interest may be identified based on time, e.g., between a first datestamp and a second datestamp displayed on graph 720 in FIG. 7A. Based on the first and second datestamps, system 100 is configured to reference the index of the stored historical data, and retrieve a subset of the stored historical data between the first datestamp and the second datestamp for generating UI data 250 for re-rendering the graph 720.

In some embodiments, after the system has cache time series data for a first rendered graph based on LLM event data, user input or otherwise, the system can be configured to cache additional data while the graph is being displayed and before the any user input is received. For example, the system can be configured to retrieve and/or cache additional time series data outside the currently displayed date range or with additional granularity.

When the user command or input for updating an existing rendered graph indicates that additional data points are required, and when a portion of the additional data points is not currently stored in the local cached database 117 based on a query of the index of the stored historical data, system 100 is configured to, in real time, connect with a data source such as external historical database 170, for retrieving additional historical data as appropriate, and storing the additional historical data in cached database 117. The index of the stored historical data is updated accordingly. Then system 100 may prepare updated UI data 250 for rendering the updated graph using the updated data in local cached database 117.

In some embodiments, when a user input is received to update the range of time series data rendered in a graph for a particular event, the system is configured to store the indices and/or offsets and/or to otherwise identify a preferred range of data to be displayed to a user for a particular event or type of event. In some embodiments, this data can be stored in association with the event data as a preferred time series range to display for a particular event. When the event data accessed for subsequent requests, the system can be configured to retrieve/cache the time series data associated with this preferred range (for requests from the same or other users).

FIG. 8A shows an example user interface 800 rendered by the user application at user device 130 based on UI data from system 100. The user interface 800 includes an updated rendered graph 820 including an UI element 810 for indicating a time window (or date) during which the temporal data set experiences a critical event (e.g., recovery of pre-event value). This updated graph 820 includes additional data points in a selected time frame (e.g., a month between Dec. 15, 1999 to Jan. 15, 2000) as determined by user input.

FIG. 8B shows an example user interface 830 rendered by the user application at user device 130 based on UI data from system 100. The user interface 830 includes an updated rendered graph 840 including an UI element 850 for indicating a time window (or date) during which the temporal data set experiences a critical event (e.g., recovery of pre-event value). This updated graph 830 includes additional data points in a selected time frame (e.g., a week between Jan. 2 to Jan. 9, 2000) as determined by user input.

FIG. 8C shows an example user interface 870 rendered by the user application at user device 130 based on UI data from system 100. The user interface 870 includes an updated rendered graph 880 including an UI element 890 for indicating a time window (or date) during which the temporal data set experiences a critical event (e.g., recovery of pre-event value). This updated graph 880 includes additional data points in a selected time frame (e.g., a day on Jan. 5, 2000) as determined by user input.

### Running a Simulation

In the example practical application, the user application at user device 130 takes the current subset of data displayed on the graph and selects a random date to run two simulations: one where $1000 is invested and another one where $1000 is withdrawn. This simulation helps in understanding the impact of investment and withdrawal actions over time. An example set of pseudo code below illustrates the simulation flow.

```
FUNCTION handleSimulation( ):
  SET animationActive, isInvestment, isRecoveryTimeUpdated TO true
  SET showFlags TO false
  recoveryPath = calculateRecoveryPath(chartDataDisplayed, isInvestment)
  actionIndex = FIND INDEX(recoveryPath, “ActionTaken”)
  recoveredIndex = FIND_INDEX(recoveryPath, “Recovered”)
  withdrawRecoveredIndex = FIND_INDEX(recoveryPath, “WithdrawlRecovered”)
  durationMessage = FORMAT_DURATION(recoveredIndex)
  durationMessageWithdrawl = FORMAT_DURATION(withdrawRecoveredIndex)
// Update UI
SET updatedHeading TO durationMessage
SET portfolioEndvalue TO {
  Investment: recoveryPath[−1].Investment,
  Withdrawl: recoveryPath[−1].Withdrawl,
  Portfolio: recoveryPath[−1].Portfolio
}
SET portfolioData TO {
  ...portfolioData,
  simulationDate: portfolioData.portfolioLowDate,
  EndingValueInvest: recoveryPath[−1].Investment,
  EndingValueWithdraw: recoveryPath[−1].Withdrawl,
  EndingValueOriginal: recoveryPath[−1].Portfolio,
  RecoveryTime: durationMessage,
  WithdrawRecoveryTime: durationMessageWithdrawl
}
ADD “Investment” TO chartDisplay.selectedOptions
SET showFlags TO true
SET showInvestment TO true
SET chartDataDisplayed TO recoveryPath
// Disable animations after 1 second
DELAY 1000 MS THEN SET animationActive TO false
```

The user application at user device 130 is configured to display the graph dynamically and adjust the data frequency based on the selected data range. This feature ensures that the data is presented in a clear and understandable manner while also optimizing performance by rendering fewer data points when the range is large.

A calculateFrequency function in an example embodiment, as shown in the example pseudo code below, determines whether to display daily, weekly, or monthly data based on the number of data points within the selected range. By adjusting the frequency, the application provides a smooth and efficient user experience, especially when dealing with extensive data sets. By displaying data at different intervals (daily, weekly, monthly), the graph remains readable and insightful, avoiding clutter. In addition, rendering fewer data points improves the performance, making the graph more responsive.

```
// Calculate data frequency for the graph
FUNCTION calculateFrequency(chartData, startIndex, endIndex):
  numDataPoints = endIndex − startIndex + 1
  prevView = currentView
  interval = DETERMINE_INTERVAL(numDataPoints)
  IF currentView IS NOT interval:
    SET showInvestment TO false
  data = [ ]
  IF interval IS “Daily”:
    FOR i FROM startIndex TO endIndex:
        ADD chartData[i] TO data
  ELSE IF interval IS “Weekly”:
    FOR i FROM startIndex TO endIndex STEP 5:
        ADD chartData[i] TO data
  ELSE IF interval IS “Monthly”:
    currentMonth = null
    FOR i FROM startIndex TO endIndex:
      currentDate = PARSE_DATE(chartData[i].name)
      month = GET_MONTH(currentDate)
      year = GET_YEAR(currentDate)
      IF month IS NOT currentMonth:
        ADD chartData[i] TO data
        currentMonth = month
  IF LENGTH OF data > 0:
    SET currentView TO interval
    RETURN data
  ELSE:
    RETURN false
// Determine the interval based on the number of data points
FUNCTION DETERMINE_INTERVAL(numDataPoints):
  IF numDataPoints < 365:
    RETURN “Daily”
ELSE IF numDataPoints < 1500: RETURN “Weekly”
  ELSE:
    RETURN “Monthly”
```

In the example pseudo code above, the Determine Interval function calculates the number of data points and sets the interval to daily, weekly, or monthly based on the range. Depending on the interval, the Data Extraction function extracts the corresponding data points:
Daily: Includes all data points.
Weekly: Includes one data point for every five, reducing the total number of points displayed.
Monthly: Includes the first data point of each month, further reducing the number of points.

The Update State function updates the currentView state to reflect the chosen interval. It also updates the chartDataDisplayed state with the filtered subset of data. This approach maintains a reference to the original, detailed dataset, ensuring the most granular data is always available while optimizing performance for the user view.

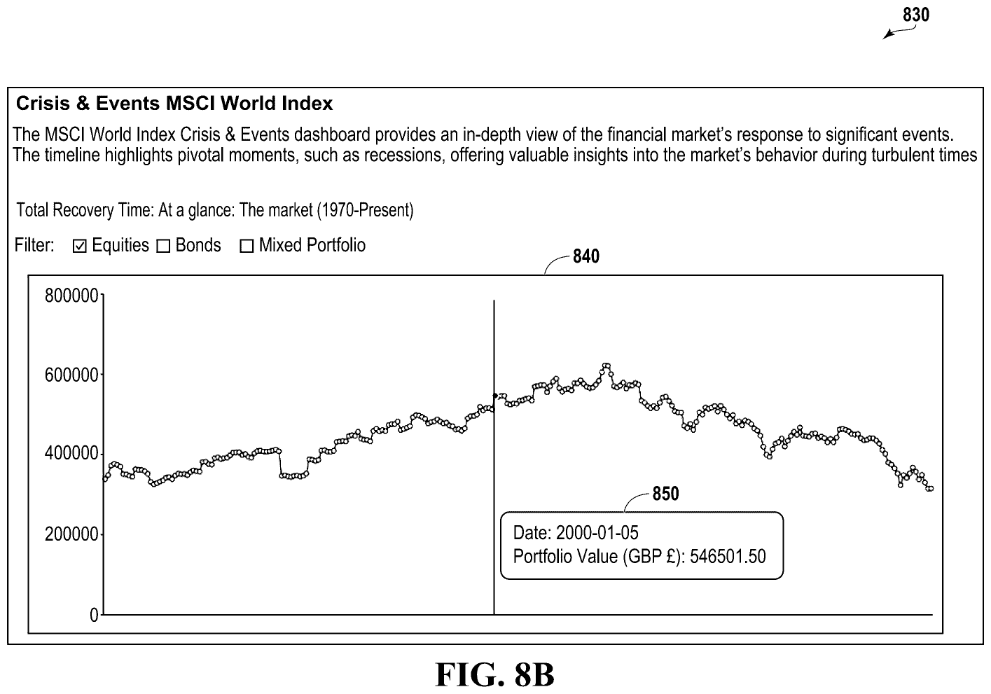

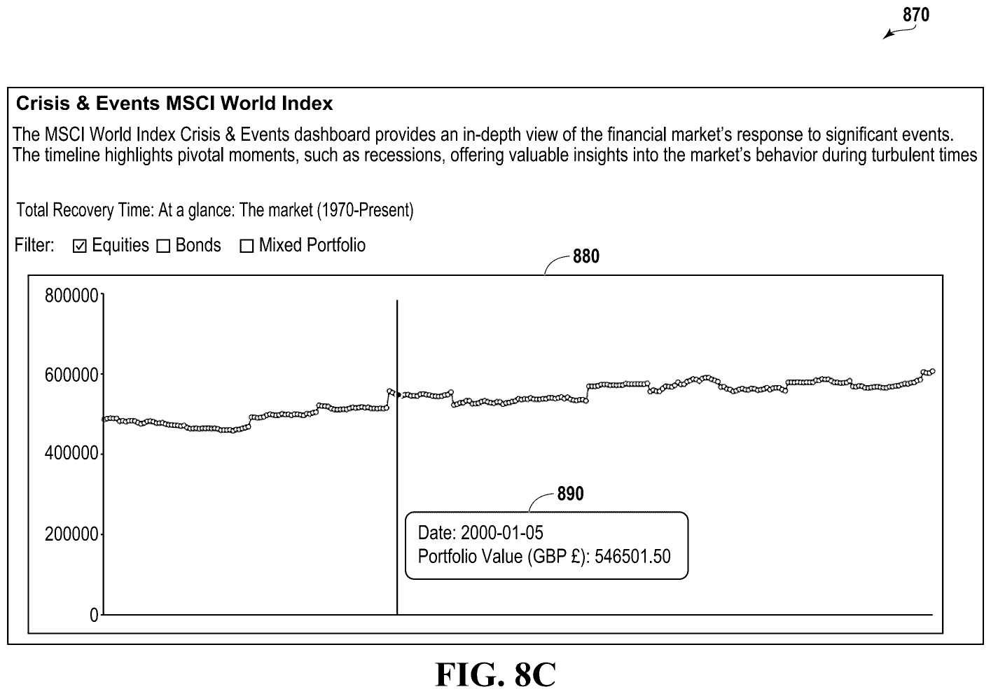

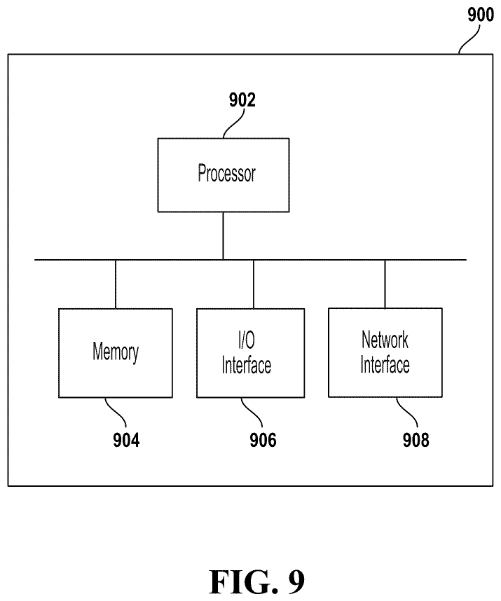

FIG. 9 is a schematic diagram of an example computing device 900 that implements a system (e.g., one or more components of system 100, or user device 130), in accordance with an embodiment. As depicted, computing device 900 includes one or more processors 902, memory 904, one or more I/O interfaces 906, and one or more network interfaces 908.

Each processor 902 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 904 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Memory 904 may store code executable at processor 902, which causes the system to function in manners disclosed herein. Memory 904 includes a data storage device or hardware. In some embodiments, the data storage device includes a secure datastore. In some embodiments, the data storage device stores received data sets, such as textual data, image data, or other types of data.

Each I/O interface 906 enables computing device 900 to interconnect with one or more input devices, such as a keyboard, mouse, camera, touch screen and a microphone, or with one or more output devices such as a display screen and a speaker.

Each network interface 908 enables computing device 900 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

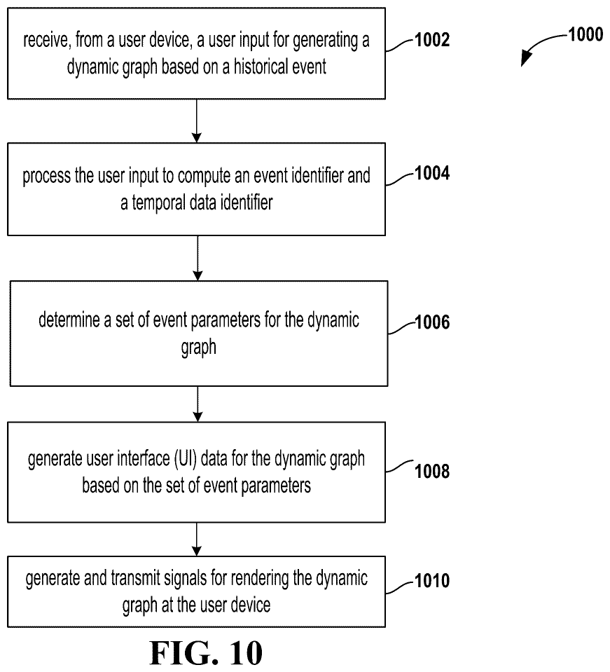

The methods and processes disclosed herein, including the process described below in view of FIG. 10, may be implemented using a system that includes multiple computing devices 900. The computing devices 900 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 900 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

FIG. 10 shows an example process 1000 performed by a system such as system 100 in FIG. 1, in accordance with some embodiments.

At operation 1002, system 100 receive, from a user device 130, a user input 210 for generating a dynamic graph based on a historical event.

In some embodiments, the user input is received through a chat interface 240 rendered on an user interface on the user device 130. The user interface may include a visual dashboard 260.

At operation 1004, system 100 can process the user input 210 to compute event data 230, which may include an event identifier and a temporal data identifier.

In some embodiments, the user input 210 is processed at least in part using a large language model (LLM) 190. System 100 can pre-process the user input 210 to generate a processed user query 220 based on an input format accepted by LLM 190.

In some embodiments, user input 210 may be processed to compute multiple temporal data identifiers. Examples temporal data identifiers may include, for example, hospitalization rate, death rate, birth rate in the healthcare industry, or equities, bonds, index, or mixed portfolio in the financial industry.

At operation 1006, system 100 can determine a set of event parameters for the dynamic graph. For example, in the example of recovering of stock portfolio during a historical event as illustrated above, the event parameters may include one or more of: a start date, an end date, a market high date, and a market low date, an event identifier, or a summary of events.

In some embodiments, the event parameters are determined based on one or more output from the LLM 190.

At operation 1008, system 100 can generate user interface (UI) data 250 for the dynamic graph based on the set of event parameters. For example, an UI graphics engine 115 of system 100 may include a server-side engine that generates UI data 250 for a client server (e.g., an application on client device 130) to render and display UI elements, which may include one or more graphs and other types of visual elements on the dashboard as part of the user interface provided by system 100.

At operation 1000, system 100 can generate and transmit signals for rendering the dynamic graph at the user device. The UI elements may be rendered entirely at the client side (e.g., user device 130), or may be partially rendered at the server side (e.g., system 100), or may be entirely rendered at the server side prior to being transmitted to client device 130.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A computer system for dynamically rendering a graph based on historical event and temporal data, the system comprising:
a processor; and
a non-transitory memory storing one or more sets of instructions that when executed by the processor, causes the system to:
receive, from a user device, a user input for generating a dynamic graph based on a historical event;
process the user input to compute an event identifier and a temporal data identifier;
determine a set of event parameters for the dynamic graph;
generate user interface (UI) data for the dynamic graph based on the set of event parameters; and
generate and transmit signals for rendering the dynamic graph at the user device.

2. The system of claim 1, wherein the user input is received through a chat interface at the user device.

3. The system of claim 1, wherein the processor causes the system to: transmit the user input to a large language model (LLM).

4. The system of claim 3, wherein the processor causes the system to receive event data from the LLM in response to transmission of the user input to the LLM.

5. The system of claim 4, wherein the event data comprises one or more of: an event identifier, an event date.

6. The system of claim 1, wherein the processor causes the system to: initialize a local database for storing a list of temporal data sets.

7. The system of claim 6, wherein the temporal data sets are indexed in the local database based on temporal stamps.

8. A computer-implemented method for dynamically rendering a graph based on historical event and temporal data, the method comprising:
receiving, from a user device, a user input for generating a dynamic graph based on a historical event;
processing the user input to compute an event identifier and a temporal data identifier;
determining a set of event parameters for the dynamic graph;
generating user interface (UI) data for the dynamic graph based on the set of event parameters; and
generating and transmit signals for rendering the dynamic graph at the user device.

9. The method of claim 8, wherein the user input is received through a chat interface at the user device.

10. The method of claim 8, wherein the processor causes the system to: transmit the user input to a large language model (LLM).

11. The method of claim 10, wherein the processor causes the system to receive event data from the LLM in response to transmission of the user input to the LLM.

12. The method of claim 11, wherein the event data comprises one or more of: an event identifier, an event date.

13. The method of claim 8, comprising: initializing a local database for storing a list of temporal data sets.

14. The method of claim 8, comprising: indexing the temporal data sets in the local database based on temporal stamps.

15. A non-transitory computer readable medium storing machine interpretable instructions, which when executed by a processor, cause the processor to perform:
receiving, from a user device, a user input for generating a dynamic graph based on a historical event;
processing the user input to compute an event identifier and a temporal data identifier;
determining a set of event parameters for the dynamic graph;
generating user interface (UI) data for the dynamic graph based on the set of event parameters; and
generating and transmit signals for rendering the dynamic graph at the user device.
